(19) United States
(12) Patent Application Publication
(10) Pub. No.: US 2015/0037703 A1
(43) Pub. Date: Feb. 5, 2015

(54) SHAPED ELECTROCHEMICAL CELL

(71) Applicant: Nuvera Fuel Cells, Inc., Billerica, MA (US)

(72) Inventor: Giampaolo Sibilia, Milan (IT)

(73) Assignee: Nuvera Fuel Cells, Inc.

(21) Appl. No.: 14/336,115

(22) Filed: Jul. 21, 2014

Related U.S. Application Data
(60) Provisional application No. 61/860,118, filed on Jul. 30, 2013.

(51) Int. Cl. H01M 8/24; H01M 8/04

(52) U.S. Cl. CPC H01M 8/2465; H01M 8/04291; H01M 8/04089
USPC 429/454; 429/452

(57) ABSTRACT

Embodiments of the present disclosure may include an electrochemical cell system. The electrochemical cell system may comprise an electrochemical cell stack having a plurality of electrochemical cells arranged in series. A first side of the electrochemical cell stack may have a first length, and a second side of the electrochemical cell stack may have a second length, wherein the first length is different than the second length.

### DESCRIPTION

This patent application claims the benefit of priority under 35 U.S.C. §120 to U.S. Provisional Application No. 61/860,118, filed on Jul. 30, 2013, the entirety of which is incorporated herein by reference.

Embodiments of the present disclosure relate to electrochemical cells, and more particularly, to electrochemical cells with specific shapes for promoting efficiency.

Electrochemical cells are devices typically used for generating current from chemical reactions or by inducing a chemical reaction using a flow of current. Electrochemical cell technology, like fuel cells and hydrogen compressors, offers a promising alternative to traditional power sources, such as fossil fuels, for a range of technologies, including, for example, transportation vehicles, portable power supplies, and stationary power production. Successful commercialization of hydrogen as an energy carrier and the long-term sustainability of a “hydrogen economy” may depend at least in part on the efficiency, output capabilities, and cost-effectiveness of electrochemical cells.

Electrochemical cells are used to generate an electric current from chemical reactions. An electrochemical cell converts the chemical energy of a fuel (a proton source like hydrogen, natural gas, methanol, gasoline, etc.) into electricity through a chemical reaction with oxygen or another oxidizing agent. The chemical reaction typically yields electricity, heat, and water. To accomplish this, a basic electrochemical cell comprises a negatively charged anode, a positively charged cathode, and an ion-conducting material called an electrolyte. Different electrochemical cell technologies utilize different electrolyte materials. A Proton Exchange Membrane (PEM) cell, for example, utilizes a polymeric, ion-conducting membrane as the electrolyte.

To generate electricity, a fuel, such as hydrogen, for example, may be delivered to an anode side of an electrochemical cell. Here, hydrogen may be split into positively charged protons and negatively charged electrons. The electrochemical reaction at the anode is 2H₂→4H⁺+4e⁻. The protons may then flow through an electrolyte membrane, such as a PEM, to a cathode side of the cell. The PEM may be configured to allow only positively charged protons to pass through to the cathode side of the cell. The negatively charged electrons may be forced to pass through an external electric load circuit to reach the cathode side of the cell, and in doing so, may generate a usable electrical current. Oxygen may be delivered to the cathode side of the cell, where it may react with the protons and the electrons to form water molecules and heat as waste. The exothermic reaction at the cathode side is O₂+4H⁺+4e⁻→2H₂O.

The cathode, electrolyte membrane, and anode of an individual electrochemical cell, may collectively form a “membrane electrode assembly” (MEA), which may be supported on both sides by bipolar plates. Gases, such as hydrogen and oxygen, may be supplied to the electrodes of the MEA through channels or grooves formed in the bipolar plates. For the purpose of this disclosure, the general terms ‘air’ and ‘gas’ may be used to describe both hydrogen and oxygen.

In operation, a single cell may generally produce a relatively small electrical potential, about 0.2-1 volt, depending on the current. To increase the total voltage output, individual electrochemical cells may be stacked together, typically in series, to form an electrochemical cell stack. The number of individual cells included in a stack may depend on the application and the amount of output required from the stack for that application.

The electrochemical cell stack may receive flows of hydrogen and oxygen, which may be distributed to the individual cells. Proper operation of the cell stack may require effective delivery of reactants, e.g., hydrogen and oxygen, to the cells and cell components. In some instances, different components of the electrochemical cells or regions of the electrochemical cell stack may operate best under different conditions, for example, slower or faster air flow.

For example, the efficiency and amount of voltage produced by an electrochemical cell may depend, at least in part, on the air stoichiometric flow rate. Air stoichiometry is the ratio of air supplied to the electrochemical cell that is necessary to react with the hydrogen fuel. A lower value of stoichiometry may reduce performance of the electrochemical cell due to a lack of reactants at the reaction sites. On the other hand, a higher value of stoichiometry may cause poor humidity control and excess compression energy. In this way, the air flow rate may also affect the amount of water in the electrochemical cell system. Accordingly, it may be desirable to control and manage the flow of gas through the electrochemical cell.

The present disclosure is directed toward the design of electrochemical cell stacks. In particular, the present disclosure is directed towards the geometric shape of electrochemical cell stacks to promote efficient air distribution, flow, and utilization across the stack. Such geometries and configurations may be used in electrochemical cells operating under high differential pressures, including, but not limited to, hydrogen compressors, fuel cells, electrolysis cells, hydrogen purifiers, and hydrogen expanders.

In accordance with one embodiment of the present disclosure, an electrochemical cell system may include an electrochemical cell stack having a plurality of electrochemical cells arranged in series. A first side of the electrochemical cell stack may have a first length, and a second side of the electrochemical cell stack may have a second length, wherein the first length is different than the second length.

Various embodiments of the disclosure may include one or more of the following aspects: the first side may be a gas input side of the electrochemical cell stack and the second side may be a gas output side of the electrochemical cell stack; the first side may be longer than the second side; the electrochemical cell stack may be substantially trapezoidal in shape; a quantity of gas may enter the first side, pass through an end plate of the electrochemical cell stack, and exit the second side; the gas entering the first side may move at a slower velocity than the gas exiting the second side; the shape of the electrochemical cell stack may promote water retention at the first side and may promote water loss at the second side; and each of the plurality of electrochemical cells may have a substantially trapezoidal shape.

In accordance with another embodiment, an electrochemical cell system may comprise an electrochemical cell stack made up of a plurality of electrochemical cells arranged in series, wherein the electrochemical cell stack has an anode end, a cathode end, a first side, and a second side opposite the first side. The system may also include a first end plate located at the anode end and a second end plate located at the cathode end, so that the first end plate and second end plate sandwich the electrochemical cell stack, and the length of the first side may be longer than the length of the second side. Gas may enter the first side of the first end plate, travel along the first end plate, and exit the second side of the first end plate, and gas may enter the first side of the second end plate, travel along the second end plate, and exit the second side of the second end plate.

Various embodiments of the disclosure may include one or more of the following aspects: the gas entering the first side may travel slower than the gas exiting the second side; the slower movement of gas at the first side may promote water retention and the faster movement of gas at the second side may promote water loss; the electrochemical cell stack may have a substantially trapezoidal shape; the electrochemical cell stack may be a fuel cell stack; the gas that enters the first end plate may be different than the gas that enters the second end plate; and the gas that enters the first end plate may include hydrogen and the gas that enters the second end plate may include oxygen.

In accordance with another embodiment, an electrochemical cell system may comprise an electrochemical cell stack including a plurality of electrochemical cells, an anode end of the electrochemical cell stack, and a cathode end of the electrochemical cell stack, wherein the electrochemical cell stack has a substantially trapezoidal geometry.

Various embodiments of the disclosure may include one or more of the following aspects: a first side of the electrochemical cell stack may be longer than a second side of the electrochemical cell stack, and the first side may be located opposite the second side; air may enter the first side at a first velocity and exit the second side at a second velocity, wherein the first velocity is different than the second velocity; the first velocity may be slower than the second velocity; and the electrochemical cell stack may be shaped like an isosceles trapezoid.

Additional objects and advantages of the embodiments will be set forth in part in the description that follows, and in part will be obvious from the description, or may be learned by practice of the embodiments. The objects and advantages of the embodiments will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention, and together with the description, serve to explain the principles of the invention.

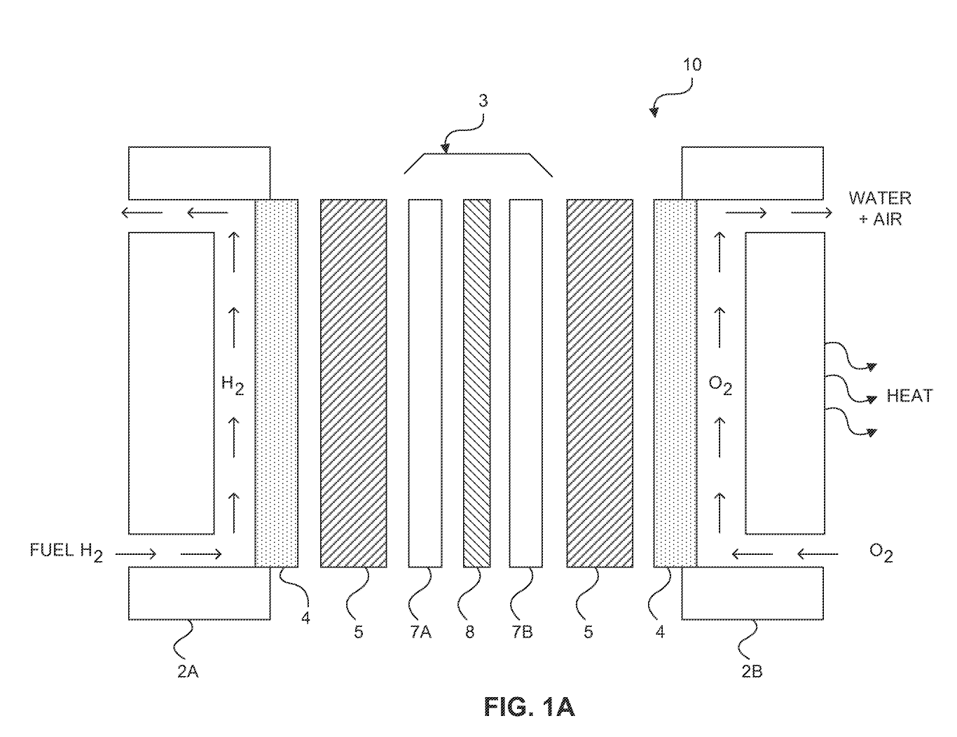

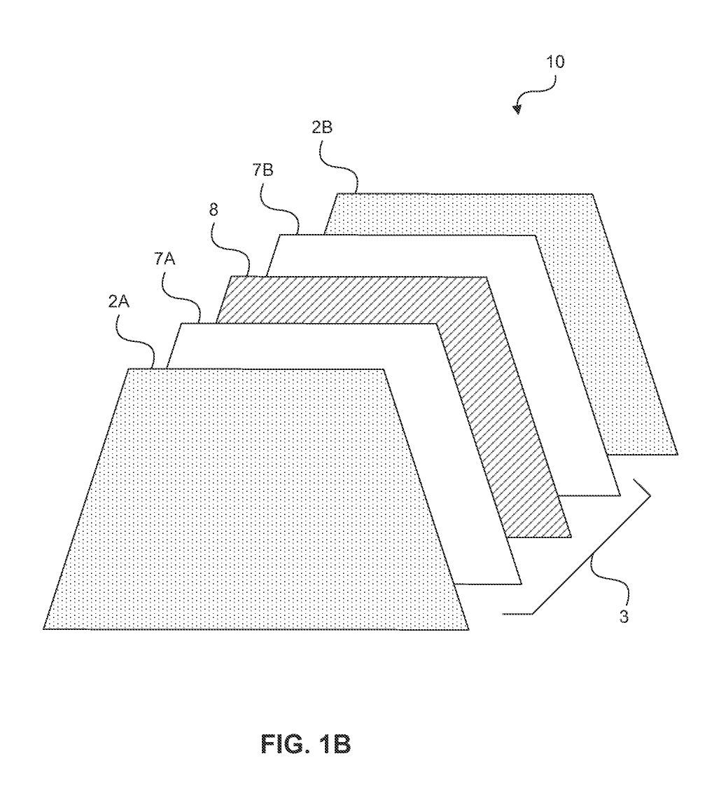

FIG. 1A illustrates an exploded side view of an exemplary electrochemical cell, according to an embodiment of the present disclosure.

FIG. 1B illustrates an exploded perspective view of the exemplary electrochemical cell shown in FIG. 1A, according to an embodiment of the present disclosure.

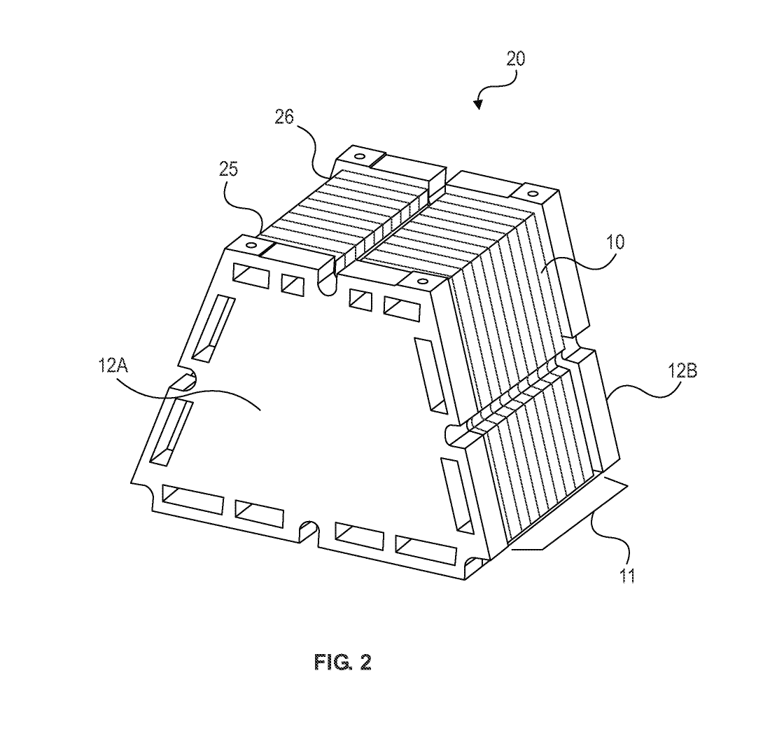

FIG. 2 illustrates a perspective view of an exemplary electrochemical cell system, according to an embodiment of the present disclosure.

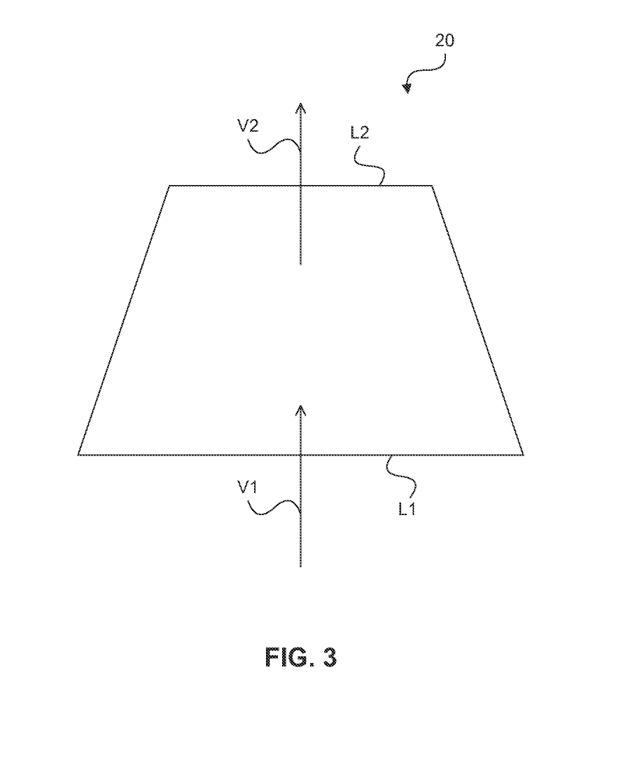

FIG. 3 illustrates a schematic view of the exemplary electrochemical cell system shown in FIG. 2, according to an embodiment of the present disclosure.

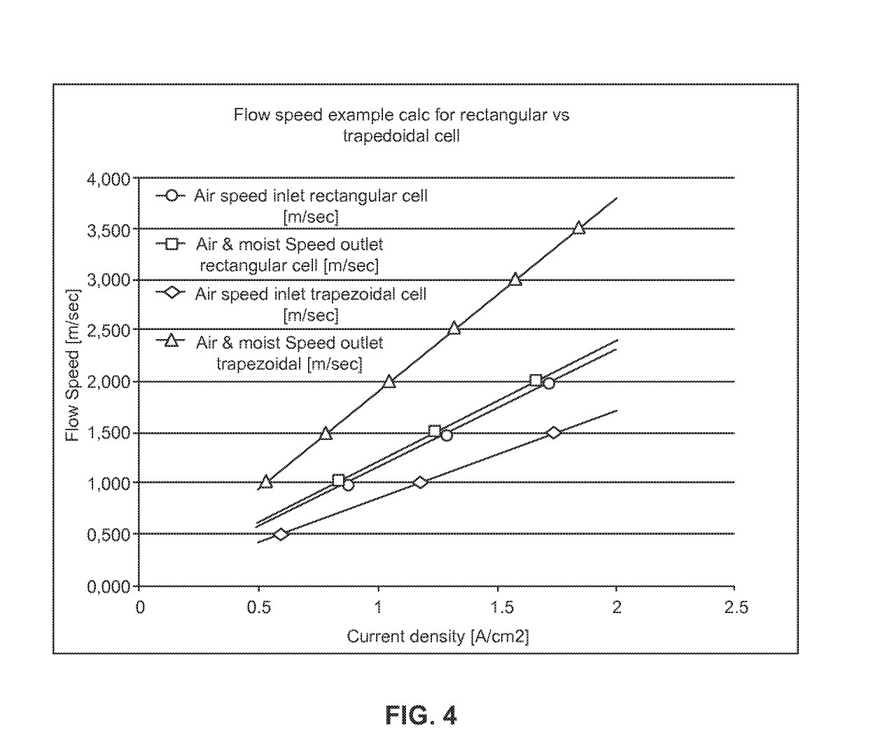

FIG. 4 is a graphical comparison of the differences in velocities in the cathode of an electrochemical cell system according to an exemplary embodiment of the present disclosure and a prior art electrochemical cell system.

Reference will now be made in detail to the exemplary embodiments of the present disclosure described below and illustrated in the accompanying drawings. Wherever possible, the same reference numbers will be used throughout the drawings to refer to same or like parts.

While the present disclosure is described herein with reference to illustrative embodiments for particular applications, such as a trapezoidal geometry for a fuel cell stack, it should be understood that the embodiments described herein are not limited thereto. Those having ordinary skill in the art and access to the teachings provided herein will recognize additional modifications, applications, embodiments, and substitution of equivalents that all fall within the scope of the invention. For example, the principles described herein may be used with any suitable electrochemical cells, including, but not limited to, hydrogen compressors, electrolysis cells, hydrogen purifiers, and hydrogen expanders. In addition, the principles may be used with any suitable type of fuel cell (e.g., direct methanol, alkaline, phosphoric acid, molten carbonate, solid oxide, and regenerative fuel cells) for any suitable application (e.g., automotive, portable, or industrial fuel cell applications). Accordingly, the invention is not to be considered as limited by the foregoing or following descriptions.

Other features and advantages and potential uses of the present disclosure will become apparent to someone skilled in the art from the following description of the disclosure, which refers to the accompanying drawings.

FIG. 1A depicts an individual electrochemical cell 10, according to an embodiment of the present disclosure. In the exploded side view shown in FIG. 1A, cell 10 includes a central, electrolyte membrane 8. Electrolyte membrane 8 may be positioned between an anode 7A and a cathode 7B. Together, electrolyte membrane 8, anode 7A, and cathode 7B may form MEA 3. Hydrogen atoms supplied to anode 7A may be electrochemically split into electrons and protons. The electrons may flow through an electric circuit (not shown) to cathode 7B, generating electricity in the process, while the protons may pass through electrolyte membrane 8 to cathode 7B. At cathode 7B, protons may react with electrons and oxygen supplied to cathode 7B to produce water and heat.

Electrolyte membrane 8 may electrically insulate anode 7A from cathode 7B. Electrolyte membrane 8 may be any suitable membrane, including, e.g., a PEM membrane. Electrolyte membrane 8 may be formed of a pure polymer membrane or a composite membrane, which may include, e.g., silica, heteropolyacids, layered metal phosphates, phosphates, and zirconium phosphates, embedded in a polymer matrix. Electrolyte membrane 8 may be permeable to protons but may not conduct electrons. Anode 7A and cathode 7B may include porous carbon electrodes containing a catalyst. The catalyst material, e.g., platinum or any other suitable material, may speed up the reaction of oxygen and fuel.

The size and shape of MEA 3 may be increased or decreased depending on the application of cell 10 and the given load requirements. For example, the thickness, length, or width of MEA 3 may be adjusted according to the given application and requirements. Additionally, the concentration of catalyst material in anode 7A and cathode 7B may be adjusted according to the given application. The concentration of catalyst material in anode 7A and cathode 7B and the thickness of electrolyte membrane 8 may each affect the total thickness of MEA 3.

In some embodiments, electrochemical cell 10 may optionally include one or more electrically conductive flow structures 5 on each side of MEA 3. Flow structures 5 may serve as diffusion media enabling the transport of gases and liquids within cell 10. Flow structures 5 may also promote electrical conduction, aid in the removal of heat and water from electrochemical cell 10, and provide mechanical support to electrolyte membrane 8. Flow structures 5 may include, e.g., flow fields, gas diffusion layers (GDL), or any suitable combination thereof. Flow structures 5 may be formed of “frit”-type sintered metals, layered structures, e.g., screen packs and expanded metals, and three-dimensional porous substrates. An exemplary porous metallic substrate may consist of two distinct layers having different average pore sizes. Such flow structures 5 may be formed of any suitable material, including, e.g., metals or metal alloys, such as, e.g., stainless steel, titanium, aluminum, nickel, iron, and nickel-chrome alloys, or any combination thereof. In addition, flow structures 5 may include a suitable coating, such as a corrosion-resistant coating, like carbon, gold, or titanium-nitride.

Flanking flow structures 5 and MEA 3, cell 10 may also include two bipolar plates 2A, 2B. Bipolar plates 2A, 2B may separate cell 10 from neighboring electrochemical cells (not shown) in a stack. In some embodiments, two adjacent cells in an electrochemical cell stack may share a common bipolar plate.

Bipolar plates 2A, 2B may act as current collectors, may provide access channels for the fuel and the oxidant to reach the respective electrode surfaces, and may provide channels for the removal of water formed during operation of electrochemical cell 10 by means of exhaust gas. Bipolar plates 2A, 2B may also provide access channels for cooling fluid, such as, e.g., water, glycol, or a combination thereof. Bipolar plates 2A, 2B may be made from aluminum, steel, stainless steel, titanium, copper, nickel-chrome alloy, graphite, or any other suitable electrically conductive material or combination of materials.

FIG. 1B illustrates a perspective, exploded view of electrochemical cell 10, including MEA 3 and end plates 2A, 2B. As is demonstrated In FIG. 1B, cell 10 has a trapezoidal geometry. Thus, each of end plates 2A, 2B, anode 7A, cathode 7B, and electrolyte membrane 8 has a substantially trapezoidal shape. The details of this shape and the effects on electrochemical cell 10 compared to traditional, rectangular electrochemical cells is discussed further below.

FIG. 2 illustrates an exemplary electrochemical cell system 20, according to embodiments of the present disclosure. Individual cells 10 may be stacked in series to form an electrochemical cell stack 11. Stack 11 may be comprised of any suitable number of cells 10. Stack 11 may be located between end plates 12A and 12B, which may be located at each end of stack 11. End plates 12A, 12B may be formed of any suitable metal, plastic, or ceramic material having adequate compressive strength, e.g., aluminum, steel, stainless steel, cast iron, titanium, polyvinyl chloride, polyethylene, polypropylene, nylon, polyether ether ketone, alumina, or any combination thereof. In some embodiments, stack 11 and end plates 12A, 12B may be housed within a suitable compression system, for example, a compression frame or between compression rods or bands.

The shape of system 20 and electrochemical cell stack 11 may be selected to promote electrochemical cell efficiency. As discussed above, the efficiency and amount of voltage produced by a electrochemical cell may depend, at least in part, on the air stoichiometric flow rate. For example, a lower value of stoichiometry may reduce performance of the electrochemical cell due to a lack of reagents at the reaction sites. On the other hand, a higher value of stoichiometry may cause poor humidity control and excess compression energy. Accordingly, it may be desirable to control and manage the flow of gas through the electrochemical cell, and oxygen and hydrogen may be delivered to and passed through the electrochemical cell system at a predetermined rate. In some embodiments, this rate may be varied across portions of electrochemical cell stack 11 to reflect different requirements within areas of electrochemical cell system 20, for example, the cathode and the anode or the air inlet and air outlet. In some embodiments, e.g., the air outlet may be better suited for handling faster moving air than the air inlet, or the cathode side of electrochemical cell stack 11 may be better suited for handling faster moving air than the anode side. It may also be desirable to supply different amounts and flow rates of air to different portions of the electrochemical cell over time to accommodate, e.g., different power demands of system 20.

In the exemplary embodiment of FIG. 2, system 20 has a substantially trapezoidal shape. As is shown in FIG. 1B, each individual cell 10 has a substantially trapezoidal shape, and the individual trapezoidal cells 10 are stacked in a series to form system 20. Stack 11 of system 20 may include any suitable number of cells 10, from two or three cells 10 to several hundred, for example. Further, while electrochemical cell system 20 is shown as an isosceles trapezoid, one of ordinary skill in the art will understand that system 20 may take any shape having sides of unequal length, for example, the long side and the short side may not be centered relative to each other, and they instead may be offset.

Trapezoidal cell stack 11 may include an anode side 25 and a cathode side 26. Hydrogen gas or air may be introduced to anode side 25, where it undergoes a chemical reaction. Hydrogen protons may pass through electrochemical cell stack 11 to cathode side 26. Further, oxygen may be introduced to cathode 26 to react with the hydrogen protons to form water and heat.

Gases, including hydrogen and/or oxygen, may be introduced to anode side 25 and cathode side 26 via end plates 12A, 12B. For example, gases may be introduced into openings in end plates 12A, 12B. Gases may enter openings in end plates 12A, 12B at an angle substantially perpendicular to cells 10 of stack 11, may turn approximately ninety degrees and run parallel along the length of cells 10, and then may again turn substantially ninety degrees to exit other openings in end plates 12A, 12B, as is shown in FIG. 1A. In some embodiments, end plates 12A, 12B may include grooves, ridges, openings, or other geometries to direct the flow of gases. For example, the geometry of end plates 12A, 12B may cause the gases to flow in a substantially linear fashion, in a serpentine direction, or may cause turbulent or smooth flow, or any other suitable manner.

In some embodiments, hydrogen may be introduced to end plate 12A adjacent anode 25, and oxygen may be introduced to end plate 12B adjacent cathode 26, or vice versa. In some embodiments, different gases may be introduced in different openings of end plates 12A, 12B, for example. The entrance and exit locations of the various gases may depend, at least in part, on the configuration of the manifold, which may distribute the gaseous reactants along the bipolar plates or around system 20.

According to the conservation of mass, the mass of air that enters a system must either leave the system or accumulate or be used within the system, as matter is neither created nor destroyed. This is often referred to as mass balance. Thus, the amount of air exiting system 20 is substantially equal to the amount of air entering minus the amount consumed in any reactions that take place within system 20. Based at least in part on this and the principles of fluid dynamics, the trapezoidal shape of system 20 may allow air entering the longer side of system 20 to travel at a lower velocity, and may allow air entering the shorter side of system 20 to travel at a higher velocity.

The air flow rate may affect the amount of water in electrochemical cell system 20, for example, promoting proper hydration or removal of produced water from the electrochemical cell. The longer side of the trapezoid and resulting lower air velocity may allow that side to promote membrane humidification. Because faster moving air increases the rate of evaporation, slowing the velocity of dry reactants introduced at the longer side may decrease the amount of moisture lost from the PEM. Maintaining proper humidity of PEM 8 may prevent PEM 8 from drying out, becoming damaged, and/or causing inadequate conductivity for ion transfer and thus a drop in the power produced by the electrochemical cell. Accordingly, the longer longer side of system 20 may improve electrochemical cell efficiency.

Conversely, as is discussed above, hydrogen protons react with oxygen at the cathode side, forming water as waste, causing liquid or vapor water to build up within system 20. Thus, the shorter side of system 20 and resulting faster air velocity may promote the removal of excess water from the shorter side. Removing water from the shorter side may be desirable, because flooding of PEM 8 may, again, cause inadequate conductivity for ion transfer and may prevent oxygen from reaching the cathode, also reducing electrochemical cell performance. Accordingly, the shorter side of system 20 may also improve electrochemical cell efficiency by removing water in the form of exhaust gas moisture.

Accordingly, introducing gases along the longer side of system 20 may promote water retention at the gas input region and allowing gases to exit along the shorter side may promote water removal at the gas exit region of end plates 12A, 12B. Further, in some embodiments, air flow may be used to promote the control of temperature or pressure in the electrochemical cell.

FIG. 3 is a schematic depiction of air flow as it enters and exits electrochemical cell system 20 in an exemplary embodiment. The arrow labeled V1 indicates the velocity of air entering the longer side of the system having a first length (L1). The arrow labeled V2 indicates the velocity of air exiting the shorter side of system 20 having a second length (L2) shorter than L1. The velocity of V2 may be higher than the velocity of V1. In some embodiments, the relationship between the length of the longer side (L1), the length of the shorter side (L2), the velocity of air at the longer side (V1), and the velocity of air at the shorter side (V2) may be described as:

$$V 2 = \frac{L 1}{L 2} V 1.$$

FIG. 4 graphically depicts an exemplary model comparing the differences in velocities in the cathode of a trapezoidal cell according to an exemplary embodiment of the present disclosure and a traditional, rectangular cell. For the calculations, it is assumed that the gas inlet and gas outlet sides of the rectangular electrochemical cell are both 220 mm. It is also assumed that the trapezoidal electrochemical cell has a gas inlet side with a length of 300 mm and a gas outlet side with a length of 140 mm.

Electrochemical cell system 20 may optionally include one or more air compressors. A compressor may provide increased regulation and management of the air pressure and flow of air traveling into stack 11 to prevent damage to electrochemical cells 10, which may supplement the benefits of the geometric shape of system 20. System 20 may include any suitable number or type of air compressor, such as, for example, reciprocating, rotary screw, single stage, or multi stage. In some embodiments, a compressor may receive and compress air from a source exterior to system 20. For example, a compressor may be operably coupled to a reactant source (not shown) configured to deliver air to the compressor, or may draw in air from the surrounding environment. In some embodiments, a compressor may be configured to recycle air exiting stack 11 so that it is re-delivered into system 20. In some embodiments, a compressor may be configured to accept air from one or more of these sources. In some embodiments, the source from which the compressor derives air may vary according to one or more factors, for example, availability, temperature, pressure, or humidity.

The substantially trapezoidal configuration of electrochemical cell system 20 may reduce reactants stoichiometry with respect to the values typically obtained by standard, rectangular electrochemical cells. Reducing air stoichiometry may in turn ease the design of hydrogen recirculation devices. For example, reducing air stoichiometry may reduce the amount of power needed for an air compressor to send air into the stacks of electrochemical cell system 20. Reducing the air compressor power may promote electrochemical cell efficiency, providing a technical benefit over other geometric shapes. For example, the table below compares the efficiency of an exemplary trapezoidal electrochemical cell system according to an embodiment of the present disclosure with a sample rectangular electrochemical cell system.

| | Stack Power gross [kW] | | |
|---|---|---|---|
| | 32 | 45 | 55 |
| Stack efficiency [—] | 55.7% | 51.8% | 47.7% |
| Air stoich rectangular | 2.0 | 2.0 | 2.0 |
| Air stoich trapezoidal | 1.4 | 1.4 | 1.4 |

Compressor power takes into account isoentroic efficiency only.
No other losses are considered

| | | | |
|---|---|---|---|
| Compressor isoentropic efficiency | 65% | 65% | 65% |
| Compressor Power Rectangular cell [kW] | 2.8 | 6.0 | 10.0 |
| Compressor Power Trapezoidal cell [kW] | 2.0 | 4.2 | 7.0 |
| Savings compressor power [kW] | 0.8 | 1.8 | 3.0 |
| Savings compressor power [%] | 30% | 30% | 30% |
| System Power rectangular [kW] | 29 | 39 | 45 |
| System Power trapezoidal [kW] | 30 | 40 | 48 |
| Delta Power [kW] | 1 | 2 | 3 |
| Delta Power [%] | 2.9% | 4.7% | 6.7% |
| Efficiency gross - compressor rectangular | 50.8% | 44.8% | 39.0% |
| Efficiency gross - compressor trapezoidal | 52.3% | 46.9% | 41.6% |
| Delta efficiency | 1.5% | 2.1% | 2.6% |

To further regulate the humidity of membranes 8 in electrochemical cells 10 of stack 11, system 20 may further include one or more humidifiers. A portion of air or all of the air delivered to stack 11 may first pass through a humidifier before entering electrochemical stack 11. In some embodiments including both compressors and humidifiers, a portion of air may first pass from a compressor into a humidifier before reaching stack 11. Alternatively or additionally, a portion of air or all of the air may be expelled from stack 11 and then passed through a humidifier and/or a compressor before reentering stack 11. For example, wet air may be expelled from stack 11 and into a humidifier, and dry air from a compressor may enter the humidifier.

In this way, one or more humidifiers or compressors, or any suitable device, may be used in conjunction with the substantially trapezoidal electrochemical cell system 20 to further promote air management and electrochemical cell efficiency. In addition, system 20 may include any suitable measuring device to measure any suitable parameter, for example, air pressure, humidity, flow speed, or temperature. Further, system 20 may include one or more controllers configured to either manually or automatically monitor and/or control the flow of air through electrochemical cell stack 11.

The many features and advantages of the present disclosure are apparent from the detailed specification, and thus, it is intended by the appended claims to cover all such features and advantages of the present disclosure that fall within the true spirit and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

Moreover, those skilled in the art will appreciate that the conception upon which this disclosure is based may readily be used as a basis for designing other structures, methods, and systems for carrying out the several purposes of the present disclosure. Accordingly, the claims are not to be considered as limited by the foregoing description.

What is claimed is:

1. An electrochemical cell system comprising:
an electrochemical cell stack including a plurality of electrochemical cells arranged in series;
a first side of the electrochemical cell stack having a first length; and
a second side of the electrochemical cell stack having a second length, wherein the first length is different than the second length.

2. The electrochemical cell system of claim 1, wherein the first side is a gas input side of the electrochemical cell stack and the second side is a gas output side of the electrochemical cell stack.

3. The electrochemical cell system of claim 2, wherein the first side is longer than the second side.

4. The electrochemical cell system of claim 3, wherein the electrochemical cell stack is substantially trapezoidal in shape.

5. The electrochemical cell system of claim 1, further comprising an end plate, wherein the system is configured so that a quantity of gas enters the first side, passes through the end plate of the electrochemical cell stack, and exits the second side.

6. The electrochemical cell system of claim 5, wherein the system is configured so that the gas entering the first side moves at a slower velocity than the gas exiting the second side.

7. The electrochemical cell system of claim 6, wherein the shape of the electrochemical cell stack promotes water retention at the first side and promotes water loss at the second side.

8. The electrochemical cell system of claim 1, wherein each of the plurality of electrochemical cells has a substantially trapezoidal shape.

9. An electrochemical cell system, comprising:
an electrochemical cell stack including a plurality of electrochemical cells arranged in series, wherein the electrochemical cell stack has an anode end, a cathode end, a first side, and a second side opposite the first side;
a first end plate located at the anode end; and
a second end plate located at the cathode end, so that the first end plate and the second end plate sandwich the electrochemical cell stack between them,
wherein the length of the first side is longer than the length of the second side,
wherein the system is configured so that gas enters the first side of the first end plate, travels along the first end plate, and exits the second side of the first end plate, and
wherein the system is configured so that gas enters the first side of the second end plate, travels along the second end plate, and exits the second side of the second end plate.

10. The electrochemical cell system of claim 9, wherein the system is configured so that gas entering the first side travels slower than the gas exiting the second side.

11. The electrochemical cell system of claim 10, wherein the system is configured so that the slower movement of gas at the first side promotes water retention and the faster movement of gas at the second side promotes water loss.

12. The electrochemical cell system of claim 9, wherein the electrochemical cell stack has a substantially trapezoidal shape.

13. The electrochemical cell system of claim 9, wherein the electrochemical cell stack is a fuel cell stack.

14. The electrochemical cell system of claim 9, wherein the first end plate is configured to receive a gas that is different than the gas that the second end plate is configured to receive.

15. The electrochemical cell system of claim 14, wherein the first end plate is configured to receive a gas that includes hydrogen, and the second end plate is configured to receive a gas that includes oxygen.

16. An electrochemical cell system, comprising:
an electrochemical cell stack including a plurality of electrochemical cells;
an anode end of the electrochemical cell stack; and
a cathode end of the electrochemical cell stack, wherein the electrochemical cell stack has a substantially trapezoidal geometry.

17. The electrochemical cell system of claim 16, wherein a first side of the electrochemical cell stack is longer than a second side of the electrochemical cell stack, and wherein the first side is located opposite the second side.

18. The electrochemical cell system of claim 17, wherein the system is configured so that air enters the first side at a first velocity and exits the second side at a second velocity, wherein the first velocity is different than the second velocity.

19. The electrochemical cell system of claim 18, wherein the first velocity is slower than the second velocity.

20. The electrochemical cell system of claim 16, wherein the electrochemical cell stack is shaped as an isosceles trapezoid.
